(19) United States
(12) Patent Application Publication
(10) Pub. No.: US 2013/0004153 A1
(43) Pub. Date: Jan. 3, 2013

(54) MOUNTING APPARATUS FOR A PORTABLE VIDEO CAPTURE DEVICE

(76) Inventors: Charles P. McKee, Rogersville, MO (US); Robert B. Noble, Springfield, MO (US)

(21) Appl. No.: 13/535,601

(22) Filed: Jun. 28, 2012

Related U.S. Application Data
(60) Provisional application No. 61/503,999, filed on Jul. 1, 2011.
(60) Provisional application No. 61/555,358, filed on Nov. 3, 2011.

(51) Int. Cl. G03B 17/00

(52) U.S. Cl. 396/420; 396/419; 396/428

(57) ABSTRACT

A mounting apparatus for a portable video capture device for recording from a substantially first person point of view including an arm assembly configured to be positioned and temporarily fixed in a plurality of angular orientations, and an adjustable clamp coupled to the arm assembly. The mounting apparatus may also include a harness to attach the mounting apparatus to a user's head, a harness mounting plate. The clamp comprises an upper and lower mounting block adjustably positioned on a shaft to secure portable video capture devices of different widths. The upper and lower mounting blocks may also be configured to secure portable video capture devices of different thicknesses. The mounting apparatus may also be configured such that the vertical position is adjustable to allow a user to view a screen on the portable video capture device in real time during video capture.

### CROSS-REFERENCE TO RELATED APPLICATIONS

This application claims the benefit of U.S. Provisional Patent Application No. 61/503,999 having a filing date of Jul. 1, 2011, and U.S. Provisional Patent Application No. 61/555,358 having a filing date of Nov. 3, 2011, both of which are incorporated herein by reference to the extent permitted by law.

### BACKGROUND OF THE INVENTION

Improvements in technology and data storage capabilities have combined to provide personal video cameras in many portable electronic devices from digital cameras, video cameras, cell phones, tablets, and others. Often these portable video capture devices are capable of taking video in high definition. Many of these electronic devices are small enough to be carried in a pocket or purse with ease. The increase in availability of these portable video devices has led to an explosion in videos being posted on sharing or social networking websites like YOUTUBE® and FACEBOOK®. One emerging trend in portable video capture is “first person” video capture wherein the video is captured from a vantage point of the person performing an action. As opposed to traditional video which captures the actions of the subject of the video, “first person” video captures the actions of the camera operator from the vantage point of the “eyes” of the camera operator and can be useful for instructional or entertainment purposes.

“First person” video has been used for some time; however, the capture of this vantage point previously required specialty equipment and rigging. There are some commercial products available that allow a user to capture “first person” video, but they have a high price point due to the fact that the purchaser is forced to purchase the video camera along with the rigging. Thus, the current state of the art appears to be a head harness or helmet with an integral video camera wherein the camera is uniquely configured to be used with that specific rigging. This configuration is no longer desirable because many portable devices now include video capture functionality and the user is required to buy another camera integrated into the rigging when they already own a device that can perform the same functions or can buy one much cheaper. This is particularly relevant now that the portable video capture devices are more user friendly because they allow a user to view and review the video captured immediately whereas, the cameras integrated into the rigging generally require the video to be transferred after use onto another device such as a laptop, desk top computer, or other video editor prior to being able to review the contents and quality. This configuration usually results in users only being able to review captured video after the user has gone off site and by then it is often too late to conveniently recapture the video in the same setting and lighting or environmental conditions.

Thus, there is a need in the art to provide a mounting apparatus that is substantially universal so that a person may use a currently owned video capture device on its own, or as incorporated into another personal electronic device that they already own, to capture “first person” videos that could be used for instructional or entertainment purposes. Further, there is a need in the art for a “first person” video capture device that allows the user to (1) view the extent of material being captured on the video while it is occurring and/or (2) immediately review the captured video to determine quality and actual content of the recorded video.

### SUMMARY OF THE INVENTION

The present invention is directed toward a mounting apparatus for mounting a personal electronic device including a video capture function to the head of a user, or to an object associated with the user or the surrounding environment in order to record video from a substantially first person view point. The mounting apparatus of the present invention is substantially universal so that a person may use a currently owned video capture device on its own or as incorporated into another personal electronic device, such as a smart phone, a cell phone, a camera, a digital video recorder, or other video capture device to capture videos in the “first person” vantage point for instructional or entertainment purposes. This invention improves over existing “first person” camera systems because the user does not have to purchase an integral camera and may create first person videos at a substantial savings by using a video capture device they already own or can purchase individually.

The mounting apparatus of the present invention includes an adjustable mounting arm assembly, and a universal device clamp assembly. The mounting apparatus may also include a harness, and a mounting plate that the adjustable mounting arm is coupled. The universal device clamp assembly is configured to secure a substantial number of available portable electronic devices that include video capture functionality. The portable electronic device is clamped between an upper and lower mounting block wherein the upper or lower mounting block (or both), may be slideable so as to secure personal electronic devices of varying widths and/or lengths. The position of the universal clamp assembly may be adjusted vertically using a mechanism such as a thumb screw incorporated into the adjustable mounting arm assembly to temporarily fix the position of the clamp assembly. Further the angular orientation of the video capture device may be adjusted by moving a radial arm having a ball that is received into a socket wherein the angular orientation of the radial arm may be adjusted and temporarily fixed for video capture.

Adjustable mounting arm assembly includes a neck, a radial arm, and a connection head. An additional embodiment includes the neck configured to be attached directly to a number of various items including: hats, caps, helmets, poles (both fixed and telescoping), a part of a motorized vehicle, human-powered vehicles, or body rigs such as a fixture attached to the body in which the video capture device is attached to allow hands-free operation of the camera.

The mounting apparatus of the present invention thereby solves the shortcomings in the art of providing a mounting apparatus allowing users to capture first person video using an off the shelf video capture device that the user currently owns or can buy independently. Further, the configuration of the mounting apparatus of the present invention allows the user to (1) view field of vision and images captured by the video capture device in real-time and/or (2) immediately review the captured video to determine quality of captured content.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views, and wherein:

FIG. 1 is a perspective view of one embodiment of a mounting apparatus constructed in accordance with the teachings of the present invention and having a personal electronic device mounted thereon;

FIG. 2 is a perspective view of the mounting apparatus of FIG. 1 without the personal electronic mounting device mounted thereon;

FIG. 3A is a perspective view of one embodiment of the mounting plate of a mounting apparatus in accordance with the teachings of the present invention;

FIG. 3B is a perspective view of one embodiment of the harness back plate of a mounting apparatus in accordance with the teachings of the present invention;

FIG. 4 is a side view of the mounting apparatus of FIGS. 1 and 2;

FIG. 5 is a side view of another embodiment of a mounting apparatus constructed in accordance with the teachings of the present invention;

FIG. 6 is a perspective view of the mounting apparatus of FIG. 5 mounted on the brim of a baseball cap; and

FIG. 7 is another perspective view of the mounting apparatus of FIG. 5 mounted on the brim of a baseball cap.

### DETAILED DESCRIPTION OF THE INVENTION

The following detailed description of the invention references the accompanying drawing figures that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and, therefore, the description is not to be taken in a limiting sense and shall not limit the scope of equivalents to which such claims are entitled.

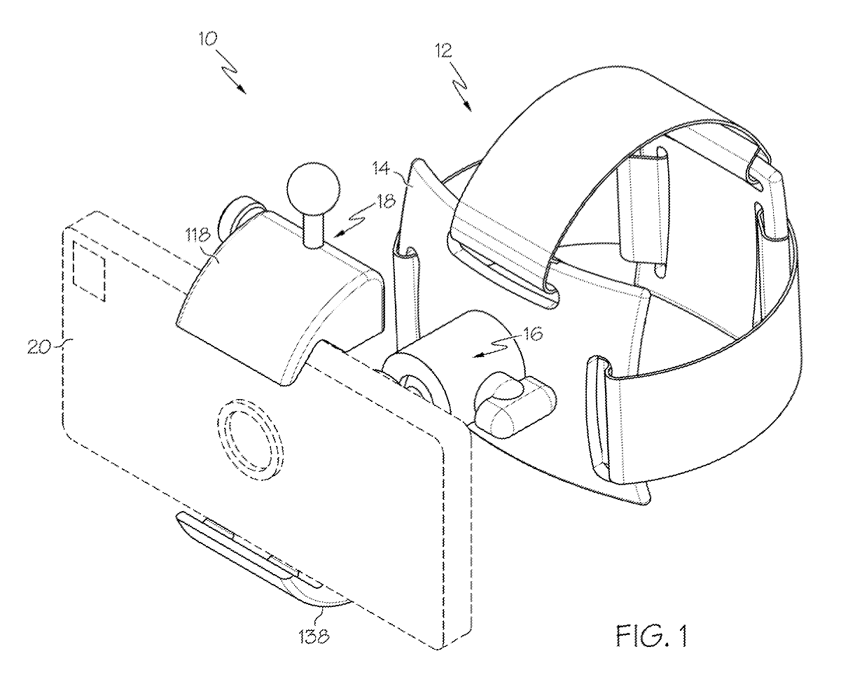

The present invention is directed towards one embodiment of a mounting apparatus 10 for mounting a personal electronic device having a video capture function to the head of a user. As seen in FIG. 1, mounting apparatus 10 of the present invention generally includes a harness 12, a harness mounting plate 14 operably connected to harness 12, an adjustable mounting arm assembly 16 operably connected to harness mounting plate 14, a universal device clamp assembly 18 slideably coupled to adjustable mounting arm assembly 16, wherein clamp assembly 18 is configured to grip and hold a portable electronic device 20 for capturing video from a “first person” vantage point. The mounting apparatus 10 of the present invention is substantially universal so that a person may use a currently owned personal electronic device having video capture functions, such as a smart phone, a cell phone, a digital camera, a digital video recorder, a tablet PC, or other video capture device that may be purchased individually or already owned to capture “first person” videos for instructional or entertainment purposes. This invention improves over existing “first person” camera systems because the user does not have to purchase the camera integrated into the rigging. A user may now use virtually any personal electronic video capture device to record videos from a “first person” vantage point.

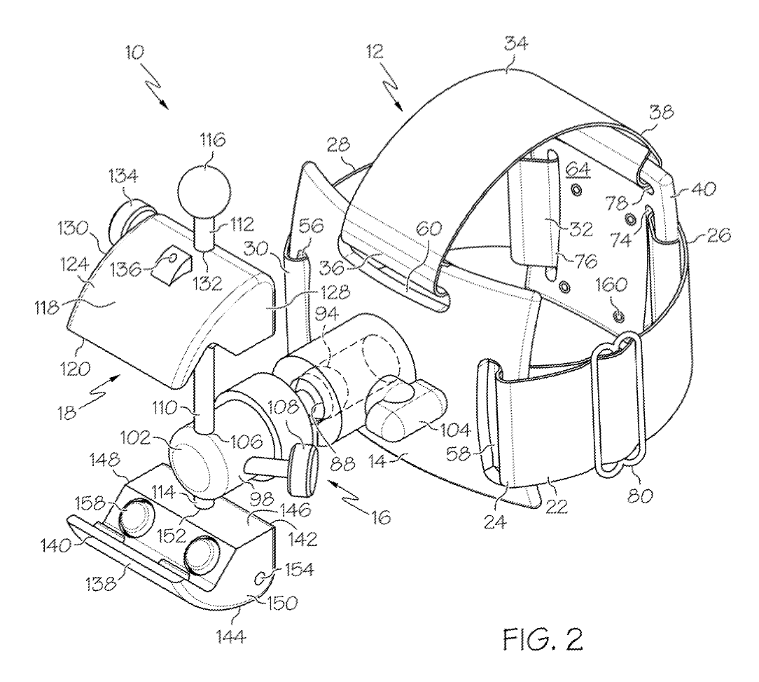

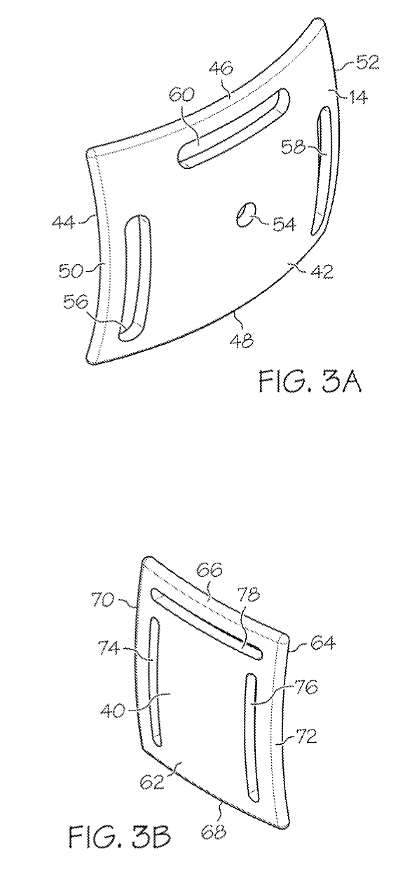

Now turning to FIG. 2, the mounting apparatus 10 of the present invention shows harness 12 comprising a first side strap 22 having a first end 24 and a second end 26, a second side strap 28 having a first end 30 and a second end 32, and a crown strap 34 having a first end 36 and a second end 38. Side straps 22, 28 and crown strap 34 are operably connected to mounting plate 14. One embodiment of mounting plate 14 is illustrated in FIG. 3A. Mounting plate 14 may have a substantially rectangular shape as shown and include a front surface 42, a back surface 44, a top 46, a bottom 48, a first side 50 and a second side 52. Mounting plate 14 may, however, be any shape known in the art including triangular, rectangular, quadrangular, pentagonal, hexagonal, or other known shape. Mounting plate 14 may also include a mounting hole 54 that facilitates coupling adjustable mounting aim assembly 16 to mounting plate 14. An embodiment of mounting plate 14 may also include alternatively front surface 42 and/or back surface 44 having double curvature as shown in FIG. 3A or, having single curvature, or being substantially flat. The curvature of mounting plate 14 may be configured to compliment various types of mounting applications including, but not limited to securing the mounting apparatus 10 directly to the front or rear of a user's head, helmets of various configurations for various sports or activities, hats, or other headwear. One embodiment may also be configured to be mounted on a user's arm or against a user's chest. The embodiment of mounting plate 14 shown in FIG. 3A further includes a first side slot 56, a second side slot 58, and a top slot 60. In addition, mounting plate 14 may have a tab or other feature (not shown) coupled to it wherein the tab or feature is configured to allow a small headlamp or other light source to be mounted thereon.

As seen in FIG. 2, one embodiment of harness 12 of the present invention further includes a back harness plate 40. As best shown in FIG. 3B, back harness plate 40 is substantially rectangular and includes a front surface 62, a back surface 64, a top 66, a bottom 68, a first side 70, and a second side 72. Back harness plate 40 may, however, be any shape known in the art including triangular, rectangular, quadrangular, pentagonal, hexagonal, or other. An embodiment of back harness plate 40 may also include front surface 62 and/or back surface 64 having double curvature as shown in FIG. 3B or, alternatively, having single curvature, or being substantially flat. The curvature of back harness plate 40 may also be configured to compliment various types of mounting applications including, but not limited to securing mounting apparatus 10 directly to the front or rear of a user's head, helmets of various configurations for various sports, hats, or other headwear. The embodiment of harness plate 40 shown in FIG. 3B further includes a first side slot 74, a second side slot 76, and a top slot 78.

Turning back to FIG. 2, straps 22, 28, and 34 are operably connected to both mounting plate 14 and back harness plate 40 to form harness 12. First end 24 of first side strap 22 is operably connected to second side slot 58 of mounting plate 14 and second end 26 of first side strap 22 is operably connected to first side slot 74 of back harness plate 40. Similarly, first end 30 of second side strap 28 is operably connected to first side slot 56 of mounting plate 14 and second end 32 of second side strap 28 is operably connected to second side slot 76 of back harness plate 40. Likewise, first end 36 of crown strap 34 is operably connected to top slot 60 of mounting plate 14 and second end 38 of crown strap 34 is operably connected to top slot 78 of back harness plate 40. The embodiment shown in FIG. 2 shows one end of each strap 22, 28, and 34 passing through the slots and then returning to be doubled over and coupled to the strap proximate one end of the strap. For example, ends of the strap may be sewn or bonded to the body of the strap in any technique known in the art for a more permanent coupling or, alternatively, the ends may incorporate a coupling mechanism to allow the straps to be removeably and/or adjustably coupled to mounting plate 14 and/or back harness plate 40. The coupling mechanism may include a button, snap, hook and loop fastener, hook, clasp, buckle, clip, ratchet buckles, or any other similar coupling mechanisms now known or hereafter developed.

The length of one or more of straps 22, 28, and 34 may be adjustable and adjustment mechanism 80 may be incorporated along the length of one or more of the straps in order to adjust its over all length. As shown in FIG. 2, strap 22 passes through adjustment mechanism 80 wherein adjustment mechanism 80 is a sliding buckle. The end of strap 22 may be operably connected to sliding buckle 80 such that sliding buckle 80 may slide along the length of strap 22 to adjust the overall length of strap 22 as known in the art. Another embodiment includes a portion of the inside or outside of strap 22 being one or more coupling mechanisms along its length, such as buttons, snaps, or hook and loop fastener wherein the effective length of strap 22 may be adjusted depending on where coupling mechanism is positioned along the length of strap 22. Further, the straps may have adjustable length provided by ladder buckles, ratchet buckles, or slide buckles or other common tightening mechanism as known in the art. Straps 28 and 34 may also incorporate the adjustable length feature described above. Straps 22, 28 and 34 may be any strapping material now known or hereafter developed including: nylon webbing, cotton, canvas, elastic fabric, rubber, soft plastics, hard plastics, elastomeric materials, neoprene, polyethylene, or combination thereof. Strap width may be any width and selected based upon one or more desired physical properties such as comfort, strength, appearance, durability, or combination thereof.

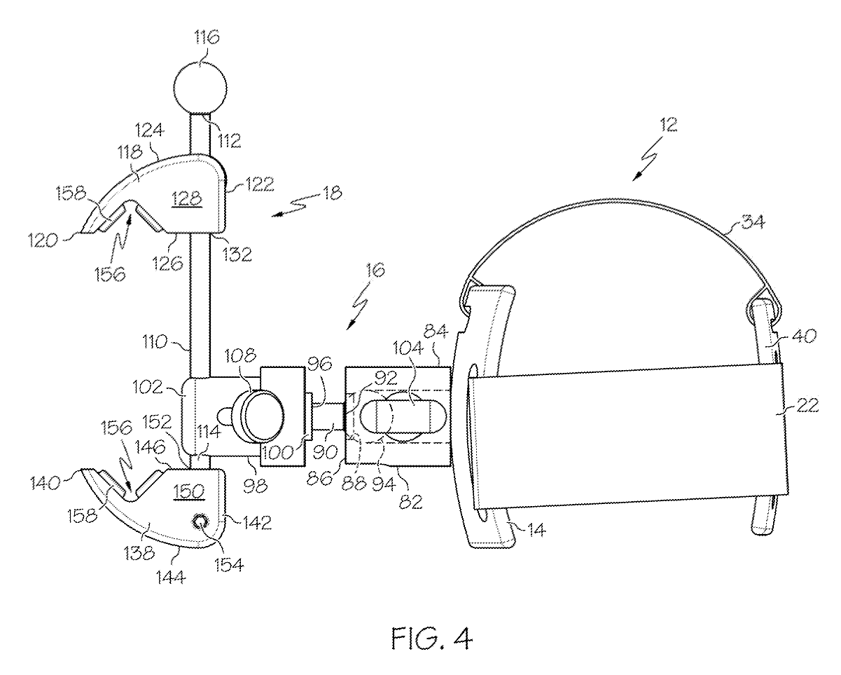

Now turning to FIG. 4, an embodiment of adjustable mounting arm assembly 16 is illustrated. Adjustable mounting arm assembly 16 includes neck 82 having a first end 84 and a second end 86 with a socket 88 defined therein proximate second end 86. First end 84 of neck 82 is coupled to front surface 42 of mounting plate 14. A fastener (not shown) may pass through mounting hole 54 of mounting plate 14 to be received by first end 84 of neck 82 to couple adjustable mounting arm assembly 16 to front surface 42 of mounting plate 14. However, neck 82 may be coupled to front surface 42 of mounting plate 14 using any known coupling method now known or hereafter developed, including, but not limited to, welds, screws, rivets, bolts, other threaded connection, or adhesives.

Adjustable mounting arm assembly 16 further comprises radial arm 90 having a first end 92 which terminates with a ball 94 and a second end 96. Ball 94 of radial arm 90 is received into socket 88 of neck 82 providing for a rotationally adjustable coupling of radial arm 90 to neck 82. The relative position of ball 94 within socket 88 can be temporarily fixed through tightening a thumb screw 104 to temporarily fix the angle of orientation of radial arm 90. Thumb screw 104 may use a cam-type configuration to secure ball 94 within socket 88. Thumb screw 104 may also incorporate any other mechanical securing method now known or hereafter developed that may secure ball 94 within socket 88 to prevent relative motion of radial arm 90 during use of the mounting apparatus 10 of the present invention, including a wedge mechanism. Second end 96 extends away from socket 88 and mounting plate 14 as shown. In addition to the embodiment shown in FIGS. 1, 2 and 4, radial arm 90 may include a telescopic configuration to allow radial arm 90 to be extended or retracted such that a user may use one of a plurality of possible lengths. A locking or securing mechanism, such as a thumb screw, may be incorporated with the telescopic radial arm to temporarily fix the length of radial arm 90.

As further illustrated in FIG. 4, adjustable mounting arm assembly 16 further comprises a connection head 98 having a first end 100 and a second end 102. First end 100 of coupling head 98 is coupled to second end 96 of radial arm 90. Second end 96 may be threaded and received into a tapped hole in first end 100 of coupling head 98. Alternatively, second end 96 may be secured to coupling head 98 using any adhesive or other mechanical connection method now known or hereafter developed including welds, screws, pins, rivets, adhesives, other threaded connection, or combination thereof.

As shown in FIGS. 2 and 4, second end 102 of coupling head 98 includes a substantially vertical hole 106 therethrough which is configured to receive a shaft 110 of universal device clamp 18. Shaft 110 slides within hole 106 and the vertical position of shaft 110 relative to connection head 98 may be fixed with a thumb screw 108. Thumb screw 108 may be in a substantially horizontal orientation as shown and threadably engaged with connection head 98 such that thumb screw 108 may be tightened to temporarily fix the vertical position of shaft 110 relative to connection head 98 or loosened to adjust the relative position of the two. However, any securing mechanism now known or hereafter developed may be used to fix the relative position of shaft 110 and connection head 98.

Shaft 110 is shown as a circular rod, but shaft 110 may comprise any cross-sectional shape in the art now known, including, triangular and rectangular. Shaft 110 includes a first end 112 and a second end 114. A safety ball 116 may be coupled to shaft 110 proximate first end 112. Safety ball 116 is a substantially spherical member that is coupled to shaft 110 through a mating threaded connection or shaft 110 may be received into an aperture in safety ball 116 and coupled with adhesive, friction, or other mechanical connection. As shown in FIG. 4, universal device clamp further comprises an upper mounting block 118 slideably coupled to shaft 110 proximate first end 112 and a lower mounting block 138 removably coupled to shaft 110 proximate second end 114. Safety ball 116 may be configured to prevent upper mounting block from sliding off of shaft 110 and/or keep first end 112 of shaft 110 from impaling or getting caught on another item while in use.

Upper mounting block 118 includes a front 120, a back 122, an outer surface 124, an inner surface 126, a first side 128 and a second side 130. Upper mounting block 118 has a shaft aperture 132, proximate back 122 extending continuously therethrough from outer face 124 to inner face 126. Shaft aperture 132 is configured for shaft 110 to pass through upper mounting block 118 such that upper mounting block 118 slides relative to shaft 110 and may be positioned along the length of shaft 110. The position of mounting block 118 along the length of shaft 110 may be temporarily fixed using thumb screw 134 as shown in FIG. 2. Thumb screw 134 may be in a substantially horizontal orientation as shown, and may be threadably engaged with upper mounting block 118 such that thumb screw 134 can be loosened or tightened to adjust or temporarily fix the position of upper mounting block 118 on shaft 110. However, any securing mechanism now known or hereafter developed may be used to temporarily fix the position of upper mounting block 118 along the length of shaft 110. As seen in FIG. 2, upper mounting block 118 may include a tab 136 that is configured for attaching a light thereto for lighting the subject matter recorded on the video capture device.

Lower mounting block 138 includes a front 140, a back 142, an outer surface 144, an inner surface 146, a first side 148 and a second side 150. Lower mounting block 138 also includes an aperture 152 proximate back 142 extending from inner surface 146 at least a distance into lower mounting block 138. One embodiment includes aperture 152 extending continuously through lower mounting block 138 extending from inner surface 146 to outer surface 144. Aperture 152 is configured to receive second end 114 of shaft 110. In the embodiment shown in FIGS. 2 and 4, lower mounting block is coupled to shaft 110 by using set screw 154. In an alternative embodiment, lower mounting block 138 may slide relative to shaft 110 and may be temporarily coupled to shaft 110 using a thumb screw in a substantially similar manner as described above for the upper mounting block 118.

As best illustrated in FIG. 4, upper and lower mounting blocks 118, 138 may have a “V” shaped notch 156 in inner surface 126, 146 proximate front 120, 140. While a “V” shaped notch is shown, a person of skill in the art would appreciate that any notch shape may be used having a similar cross-section, particularly shapes having a gradually narrowing width such as the “V” shape including: a parabolic shape, semi-circular shape, or an oval shape wherein the width of notch 156 narrows as is extends inward. The narrowing notch 156 is preferable as it facilitates allowing upper and lower mounting blocks 118, 138 to secure video capture devices 20 having various thicknesses. Further, to assist in gripping and securing video capture device 20 between upper mounting block 118 and lower mounting block 138, grip pads 158 may be coupled to the side walls of the “V” notch as shown in FIGS. 2 and 4. Grip pads 158 may be a rubber bumper used to grip the video capture device 20 without causing any permanent marks or damage to the exterior of the video capture device. Grip pad 158 may be any material now known or hereafter developed that improves the grip of the clamp with in the clamp assembly 18, including: elastomeric, neoprene, polymeric, cork, rubber, encapsulated gel, foam or any combination thereof. As shown in FIG. 2, similar harness grip pads 160 may be included upon back surface 44 of harness back plate 40 and/or back surface 64 of mounting plate 14 to provide protection of the user's head, or provide extra grip of the harness plate and/or mounting plate 14 on a helmet or other element the harness is mounted to.

An alternative to having a notched block, upper and lower mounting blocks 118 and 138 may each comprise two pieces that are adjustably coupled together and configured to clamp the video capture device 20 between the two pieces. The two pieces may be coupled with a coupling mechanism now known or hereafter developed that provides a compressive clamping force upon the two pieces of the mounting blocks 118 and 138 sufficient to secure the video capture 20 device during use.

In use, as illustrated in FIG. 1, a user will secure personal electronic device 20 in the universal adjustable clamp assembly 18. Thumb screw 134 is loosened such that upper mounting block 118 can be slid upon shaft 110 and upper mounting block 118 is slid upwardly toward first end 112 of shaft 110. A bottom or side edge of personal electronic device 20 is placed in the “V” shaped notch 156 of lower mounting block 138 as shown in FIG. 1. The personal electronic device 20 is positioned such that its lens faces the direction in which video footage is to be captured. Many times, the surface of the electronic video capture device 20 facing the user includes a screen that can be used to see the captured video in “real time” and to view video captured in a playback mode. Upper mounting block 118 is slid downward such that “V” shaped notch 156 in inner surface 126 of upper mounting block 118 receives a top or opposing side edge of portable video capture device 20.

Thumb screw 134 is tightened to temporarily fix the position of upper mounting block 118 on shaft 110 thereby clamping personal electronic device 20 in clamp assembly 18. Upper mounting block 118 may be positioned and temporarily fixed along shaft 110 such that clamp assembly 18 may secure portable video capture device 20 having different lengths or widths. The sides of personal electronic device 20 may bear upon grip pads 158 wherein grip pads 158 may slightly elastically deform to better grip personal electronic device 20 and/or provide increased frictional resistance to help prevent the device 20 from slipping out of the clamp 18. It will be appreciated that an embodiment of the present invention may secure a portable video capture device between upper mounting block 118 and lower mounting block 138 when at least one mounting block 118, 138 is slidable upon shaft 110. A person of skill in the art will appreciate that only one mounting block 118, 138 must be slidable relative to the other mounting block on shaft 110 to secure a portable video capture device 20 therebetween. Further, as shown in FIG. 1, upper and lower mounting blocks 118 and 138 may be configured to secure a portion of portable video capture device 20 thereby allowing clamp assembly 18 to secure portable video capture devices 20 having different lengths or widths depending upon the orientation of the device.

Once video capture device 20 is secured between upper mounting block 118 and lower mounting block 138, the user may place harness 12 over the user's head, helmet, hat, cap, or any other head covering. The user will position harness mounting plate 14 proximate the user's forehead, on the front of a helmet, or on other desired mounting surface. The user will then stretch out or loosen side straps 22 and 28 such that back harness plate 40 and the opening defined between side straps 22 and 28 is larger than and can be positioned around the user's head, helmet, or head covering. Once harness 12 is positioned around the user's head, helmet, or head covering, about at level with the user's temples, the straps 22 and 28 are tightened to secure harness 12 to user's head or helmet. Straps 22 and 28 may be elastic and provided in a one-size fits all configuration where the elastic straps are one length and the harness relies on the elasticity to tighten harness 12 around the head or helmet.

Alternatively, straps 22 and 28 may be adjustable so that they can be tightened around the user's head using a strap length adjustment mechanism 80, or may comprise a combination of both elastic and adjustment mechanisms. Crown strap 34 may engage the top of the user's head, helmet, or head covering or may be tightened to do so. Crown strap 34, if present, prevents the mounting apparatus 10 of the present invention from sliding downward over the user's head and disrupting the capture of video. Mounting plate grip pads 160 may engage the user's head or helmet to provide extra grip between the harness and the user. Often, helmets or other head coverings are configured with buckles and/or other mechanisms to retain straps of items such as goggles and straps 22 and 28 may engage such mechanisms to further secure harness 12 on user's head. Harness 12 may be configured to secure the mounting apparatus 10 of the present invention to other portions of a user's person, such as a chest, arm, leg, waist, hand, foot, shoulder, etc. In addition, harness 12 may be configured to secure mounting apparatus of the present invention to any other stationary or moving object such as a bike, car, motorcycle, house, stand, tripod, moving ball, airplane, glider, skis, boat, handle bars, oven, refrigerator, heavy machinery, appliances, tools, and any other item now known or hereafter developed.

Next, the vertical position of video capture device 20 may be adjusted by loosening thumb screw 108 thereby allowing shaft 110 to slide relative to mounting arm assembly 16 and within aperture 106 until the desired vertical position of the video capture device 20 is obtained. Once the position of shaft 110 relative to mounting arm assembly 16 is obtained, the user can tighten thumb screw 108 to temporarily fix the position of shaft 110 in aperture 106. Some users may want the video capture device 20 lower such that it is easy to look up to see the field of view in the screen of video capture device 20. Some users may want video capture device 20 to be higher and out of the user's immediate field of vision. The mounting apparatus 10 of the present invention is configured to provide for these varying vertical positions of video capture device 20 as well as those in-between. The vertical position of video capture device 20 may also be configured prior to mounting harness 12 upon the user's head, helmet, or head covering.

In addition, the user may adjust the angular orientation of the device by adjusting mounting arm assembly 16. A user may loosen thumb screw 104 such that ball 94 of radial arm 90 may be radially adjusted within socket 88. As a person of skill in the art will appreciate, a ball-in-socket connection allows for a plurality of angular orientations of radial arm 90 with respect to neck 82. Radial arm 90 may be adjusted horizontally to either side to capture video of what the user would see if looking to one side or the other. Further, radial arm 90 may be adjusted vertically to provide a default position of capturing video of what the user would see if looking upward or downward. The radial adjustment also provides the user the ability to adjust the orientation of video capture device 20 to suit an individual's head shape, or the configuration of a helmet or other head covering. The radial adjustment feature of radial arm assembly 16 allows a user to compensate for the slopes and position the mounting plate has on a user's forehead, helmet, or other head covering thereby allowing the same camera angle to be reproduced on any user.

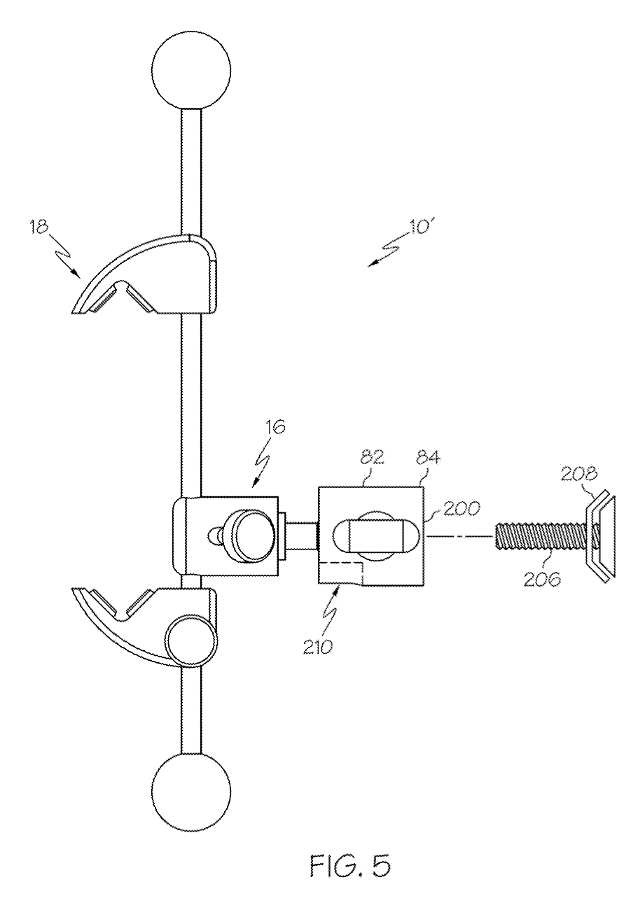

An additional embodiment of mounting apparatus 10′ illustrated in FIGS. 5-7 is substantially identical to that described above but is configured to be attached to various bodies or objects rather than the user's head. As shown in FIG. 5, the embodiment comprises mounting arm assembly 16, and universal device clamp assembly 18 slideably coupled to mounting arm assembly 16. Clamp assembly 18 is similarly configured to grip and hold portable electronic device 20 as shown in FIGS. 5, 6, and 7. Mounting arm assembly 16 has first end 84 of neck 82 configured to be coupled directly to a number of various bodies including, but not limited to: hats, caps, helmets, shoulder pads, torso harness, poles (both fixed and telescoping), a component of a motorized vehicle (including, but not limited to a handle bar, mirror, dash, hood, body panel, seat, brake, pedal, wheel well, tire, axle, bumper, trunk, motor, engine, transmission, seat, or floor), a component of a human-powered vehicle (bike components, seat, handle bar, frame, fender, or handle), skis, skateboards, golf clubs, chairs, benches, tables, counters, computer screens, shelves, containers, books, speakers, electronic components, pots, pans, appliances, tools, walls, ceilings, or other bodies configured to be supported by a user's person, head, limbs, torso, or other bodies or objects associate with a particular environment to allow hands-free operation of the camera.

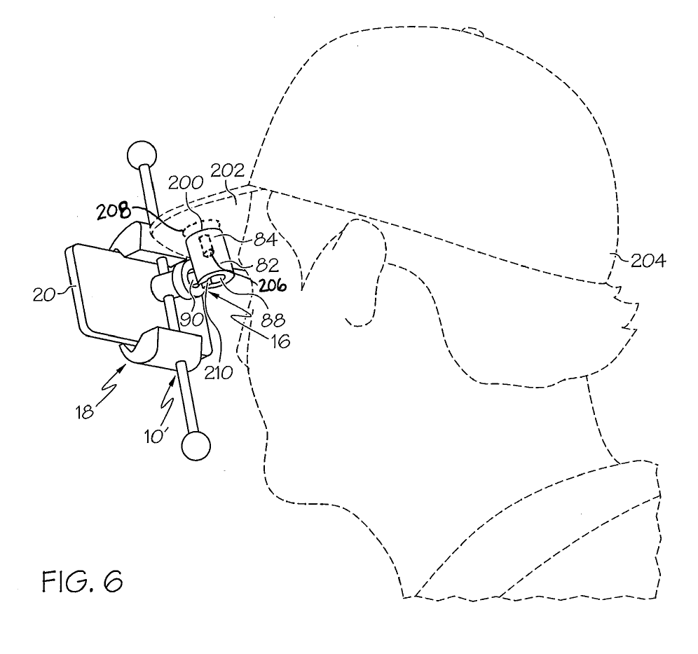

As shown in FIGS. 5 and 6, first end 84 of neck 82 includes a first end surface 200 that is substantially planar to be coupled to a generally planar object such as the brim 202 of baseball cap 204 as shown. Alternatively, first end surface 200 of neck 84 may have a concave, convex, or a double curvature shape such that mounting arm assembly 16 may be fastened to a number of various objects having generic shapes of flat, convex, or concave, or a combination thereof, as necessary or to compliment the shape of the object that mounting apparatus is being mounted thereon. A person of skill in the art will appreciate, however, that the exact shape defined by end surface 200 is distinct from the novel concept of mounting device 10′ of the present invention as described herein.

One embodiment includes mounting apparatus 10′ being coupled to an object using fastener 206 that is inserted through an aperture (not shown) in the object and received into first end 84 of neck 82 as shown in FIG. 5. Fastener 206 may also be used in conjunction with a washer or grommet 208 as known in the art for many purposes including, preventing the fastener from penetrating the object or from tearing the object upon external forces being applied to mounting apparatus 10′. In addition to fastener 206, neck 82 may be coupled to any object using any fastening mechanism known in the art, such as: screws, bolts, clamps, rivets, adhesives, hook and loop fasteners, or any other method now known or hereafter developed.

FIG. 6 illustrates how mounting apparatus 10′ is mounted to the brim of a baseball hat. In this embodiment, fastener 206 is inserted through washer 208 and through a hole (not shown) in the brim of the hat and received by neck 82 proximate first end section 200.

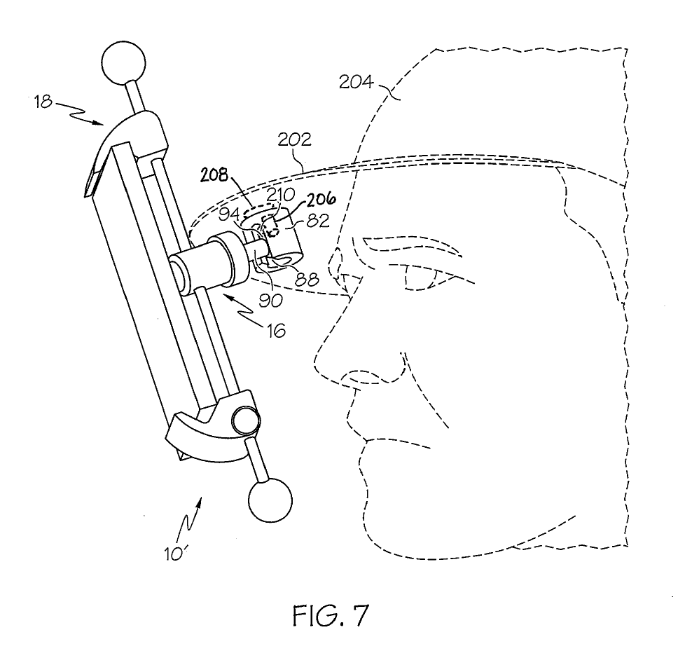

FIG. 7 illustrates how ball 94 of radial arm 90 is radially adjusted within socket 88 and can be moved within a slot 210 in neck 82 to position radial arm 90 in any orientation from parallel to neck 82 as shown in FIG. 5, to being substantially perpendicular to neck 82 as shown in FIGS. 6 and 7. As can be seen in FIGS. 6 and 7, radial arm 90 extends away from neck 82 and brim 202. In addition, the configuration of mounting apparatus 10′ of the present invention as described herein further allows a user to view the screen of video capture device 20 while recording video in real time as shown in FIG. 7. This feature also allows the user to determine and/or adjust the focal object in the capture frame to ensure that the desired subject matter is being captured. Further, incorporating existing video capture device 20 as shown allows a user to review the recording immediately after it is taken on a display screen as this feature is included in almost all of personal electronic devices having video capture functionality.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

We claim:

1. A mounting apparatus for a portable video capture device comprising:
an arm assembly having a first end and a second end, said first end being adapted for being attached to a body and said arm assembly extending away from said body; and
an adjustable clamp coupled to said second end of said arm assembly wherein said adjustable clamp is configured to secure one of a plurality of different portable video capture devices having different lengths, widths, and thicknesses.

2. The mounting apparatus of claim 1 wherein said adjustable clamp further comprises an upper mounting block and a lower mounting block wherein at least one of said upper mounting block or said lower mounting block is adjustable relative to the other.

3. The mounting apparatus of claim 2 wherein said upper mounting block and said lower mounting block each include a notch configured to receive a portion of said portable video capture device.

4. The mounting apparatus of claim 2 wherein both said upper mounting block and said lower mounting block are adjustable relative to the other.

5. The mounting apparatus of claim 2 wherein said upper mounting block is coupled to a shaft proximate a first end of said shaft and said lower mounting block is coupled to said shaft proximate a second end of said shaft, wherein at least one of said mounting blocks is slidable relative to said shaft.

6. The mounting apparatus of claim 5 wherein said upper mounting block and said lower mounting block include a notch therein wherein said notch is configured to receive a portion of said portable video capture device therein.

7. The mounting apparatus of claim 5 wherein said shaft is moveable in a vertical direction relative to said arm assembly.

8. The mounting apparatus of claim 7 wherein a vertical position of said adjustable clamp relative to said arm assembly is temporarily fixed with a securing mechanism.

9. The mounting apparatus of claim 8 wherein said vertical position allows the user to view video being captured in real-time on a screen of said portable video capture device.

10. The mounting apparatus of claim 5 wherein said shaft is coupled to said aim assembly between said upper mounting block and said lower mounting block.

11. The mounting apparatus of claim 1 wherein said arm assembly is angularly adjustable relative to said body.

12. The mounting apparatus of claim 11 wherein said arm assembly includes a neck coupled to said harness mounting plate, said neck having a socket, a radial arm comprising a ball on one end, said ball being housed within said socket and secured therein thereby allowing said radial arm to be positioned and temporarily fixed in a plurality of angular orientations.

13. The mounting apparatus of claim 12 wherein the position of said ball within said socket is temporarily fixed with a securing mechanism.

14. The mounting apparatus of claim 1 wherein said body is a harness configured to attach said mounting apparatus to a user's head.

15. The mounting apparatus of claim 14 wherein said harness includes a harness mounting plate and said arm assembly is coupled to said harness mounting plate.

16. The mounting apparatus of claim 1 wherein said body is selected, from a group consisting of a hat, cap, helmet, torso harness, pole, component of a motorized vehicle, component of a human-powered vehicle, ski, skateboard, golf club, chair, bench, table, counter, computer screen, shelf, container, appliance, and tool.

17. A mounting apparatus for a portable video capture device comprising:
a harness configured to attach said mounting apparatus to a user's head;
a harness mounting plate operably connected to said harness;
an arm assembly having a first end and a second end, said first end coupled to said harness mounting plate and said arm assembly extending away therefrom wherein said arm assembly is angularly adjustable relative to said harness mounting plate; and
an adjustable clamp coupled to said second end of said arm assembly wherein said adjustable clamp is configured to secure one of a plurality of different said portable video capture devices.

18. The mounting apparatus of claim 17 wherein a relative position of said adjustable clamp relative to said arm assembly is adjustable in a substantially linear direction.

19. A mounting apparatus for a portable video capture device comprising:
an arm assembly configured to attach said mounting apparatus to a body, said arm assembly comprising a neck having a first end and a second end, said first end of said neck coupled to a body and said second end of said neck comprising a socket, a radial arm having a first end and a second end, said first end of said radial arm comprising a ball housed within said socket and secured therein such that said ball is angularly adjustable relative to said socket thereby allowing said radial arm to be positioned and temporarily fixed in a plurality of angular orientations, said radial arm extending away from said socket, and a connection head coupled to said second end of said radial arm; and
an adjustable clamp comprising a shaft having a first end and a second end, said shaft slidably coupled to said connection head, an upper mounting block slidably coupled proximate said first end of said shaft and a lower mounting block slidably coupled proximate said second end of said shaft and wherein said upper mounting block and said lower mounting block are adjustable relative to each other and configured to secure one of a plurality of portable video capture devices.

20. The mounting apparatus of claim 19 wherein said upper mounting block and said lower mounting block each include a notch configured to receive a portion of said portable video capture device

21. The mounting apparatus of claim 20 wherein a width of said notch narrows as said notch extends inwardly.

22. The mounting apparatus of claim 17 wherein the vertical position of said shaft relative to said connection head is temporarily fixed with a securing mechanism.

23. The mounting apparatus of claim 17 wherein said upper mounting block further includes a tab configured for mounting a light.

24. The mounting apparatus of claim 17 wherein said body is a harness configured to attach said mounting apparatus to a user's head.

25. The mounting apparatus of claim 17 wherein said body is selected from a group consisting of a hat, cap, helmet, torso harness, pole, component of a motorized vehicle, component of a human-powered vehicle, ski, skateboard, golf club, chair, bench, table, counter, computer screen, shelf, container, appliance, and tool.
